(19) United States
(12) Patent Application Publication
(10) Pub. No.: US 2025/0086159 A1
(43) Pub. Date: Mar. 13, 2025

(54) METHOD AND SYSTEM FOR MANAGING TABLES METADATA

(71) Applicant: INFOYSY LIMITED, Bangalore (IN)

(72) Inventor: GOPIKRISHNA GOGINENI, Bangalore (IN)

(21) Appl. No.: 18/387,356

(22) Filed: Nov. 6, 2023

(30) Foreign Application Priority Data
Sep. 8, 2023 (IN) 202341060606

(51) Int. Cl. G06F 16/23; G06F 16/22

(52) U.S. Cl. CPC G06F 16/2365; G06F 16/21; G06F 16/2282; G06F 16/23

(57) ABSTRACT

This disclosure relates to a method and a system for managing metadata of a table. The method includes receiving a user input corresponding to the table. The table is one an existing table or a new table, and the user input is for at least one of a modification of the existing table, or a creation of the new table. The method further includes retrieving at least one predefined policy associated with an entity. The at least one predefined policy is associated with a metadata element within metadata of the table. The metadata includes information associated with the table in compliance with requirements of the entity. The method further includes validating the user input based on the at least one predefined policy. The method further includes permitting a user to perform an action corresponding to the table based on the user input, upon the successful validation.

### CROSS-REFERENCE TO RELATED APPLICATION

This application claims priority to Indian Patent Application No. 202341060606, filed on Sep. 8, 2023, which is hereby incorporated by reference in its entirety.

### TECHNICAL FIELD

This disclosure relates generally to metadata, and more particularly to a method and a system for managing metadata of tables.

### BACKGROUND

Metadata can be defined as ‘data about data’, i.e., data that provides information about one or more aspects of the data. In structured data stored in tabular format, certain information like list of columns in the table, data type of each column, length of the column, indexes on the table, constraints on the table, etc., are obtained from Data Definition Language (DDL) of the table in the database. This data provides extremely useful information about the tables during any analysis to be carried out on the database. Many databases store this data associated with the tables in separate tables and provide facility to query on it. However, metadata associated with the tables that is either related to business domain information, process related information, or any other data (apart from the data that is present in the DDL of the table), such as, business function, business definitions of the columns and the tables, business relationship between various tables or columns, maintenance details of the tables, which process loads the table, which team owns the table, what is the load frequency of the table, etc., are typically maintained in other specialized applications or in separate tables within the same database by the organization.

Hence there is no tight coupling between actual data present within the tables and their corresponding metadata. Further, tracking and maintaining of such metadata of the table, like business definitions, table business definitions, etc., is a tedious task and is challenging. Currently there is no standard way of storing and maintaining this metadata or enforcing to store this metadata within the same table. Some of the currently existing techniques used by the organizations for tracking the metadata of the tables involves usage of other independent tools or independent tables in the database.

In addition, organziations currently set up various processes where teams are requested to update the metadata information associated with the tables before making any changes in the table at the database level. For this, organizations typically create manual processes asking developers to update the metadata of the tables in third-party applications or independent tables maintained by the organization, but there is no technical way to enforce this updation. This manual processes are often followed religiously during starting days but as the days goes by, the developers typically tend to ignore this crucial step of updating the metadata, to an extent. Due to this, over a period of time the metadata of the table falls out of sync with the data within the table and becomes unreliable. This happens largely because the updation of the metadata is verbally or manual enforced by the organizations on the teams.

There is, therefore, a need in the present state of art, for techniques to address the problem of manual updation of metadata associated with the tables.

### SUMMARY

In one embodiment, a method for managing metadata of a table is disclosed. In one example, the method may include receiving a user input corresponding to the table. It should be noted that the table may be one an existing table or a new table, and the user input is corresponding to at least one of a modification of the existing table, or a creation of the new table. The method may include retrieving at least one predefined policy associated with an entity, upon receiving the user input. It should be noted that the at least one predefined policy is associated with a metadata element within metadata of the table. The metadata may include information associated with the table in compliance with requirements of the entity. The method may include validating the user input based on the at least one predefined policy. It should be noted that the validation may be one of a successful validation or an unsuccessful validation. The method may include permitting a user to perform an action corresponding to the table based on the user input, upon the successful validation.

In one embodiment, a system for managing metadata of a table is disclosed. In one example, the system may include a processor and a computer-readable medium communicatively coupled to the processor. The computer-readable medium may store processor-executable instructions, which, on execution, may cause the processor to receive a user input corresponding to the table. It should be noted that the table may be one an existing table or a new table, and the user input is corresponding to at least one of a modification of the existing table, or a creation of the new table. The processor-executable instructions, on execution, may further cause the processor to retrieve at least one predefined policy associated with an entity, upon receiving the user input. It should be noted that the at least one predefined policy may be associated with a metadata element within metadata of the table. The metadata may include information associated with the table in compliance with requirements of the entity. The processor-executable instructions, on execution, may further cause the processor to validate the user input based on the at least one predefined policy. It should be noted that the validation may be one of a successful validation or an unsuccessful validation. The processor-executable instructions, on execution, may further cause the processor to permit a user to perform an action corresponding to the table based on the user input, upon the successful validation.

In one embodiment, a non-transitory computer-readable medium storing computer-executable instructions for managing metadata of a table is disclosed. In one example, the stored instructions, when executed by a processor, cause the processor to perform operations including receiving a user input corresponding to the table. It should be noted that the table may be one an existing table or a new table, and the user input is corresponding to at least one of a modification of the existing table, or a creation of the new table. The operations may further include retrieving at least one predefined policy associated with an entity, upon receiving the user input. It should be noted that the at least one predefined policy may be associated with a metadata element within metadata of the table. The metadata may include information associated with the table in compliance with requirements of the entity. The operations may further include validating the user input based on the at least one predefined policy. It should be noted that the validation may be one of a successful validation or an unsuccessful validation. The operations may further include permitting a user to perform an action corresponding to the table based on the user input, upon the successful validation.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 illustrates a block diagram of an environment for managing metadata of a table, in accordance with an exemplary embodiment of the present disclosure.

FIG. 2 illustrates a block diagram of a computing device configured for managing metadata of a table, in accordance with an exemplary embodiment of the present disclosure.

FIG. 3 illustrates a flow diagram of an exemplary process for managing metadata of a table, in accordance with an exemplary embodiment of the present disclosure.

FIG. 4 illustrates a flow diagram of an exemplary process of validating a user input, in accordance with an exemplary embodiment of the present disclosure.

FIG. 5 illustrates a flow diagram of an exemplary process of applying predefined policies on a table, in accordance with an exemplary embodiment of the present disclosure.

FIG. 6 is a block diagram that illustrates a system architecture of a computer system for managing metadata of a table, in accordance with an exemplary embodiment of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

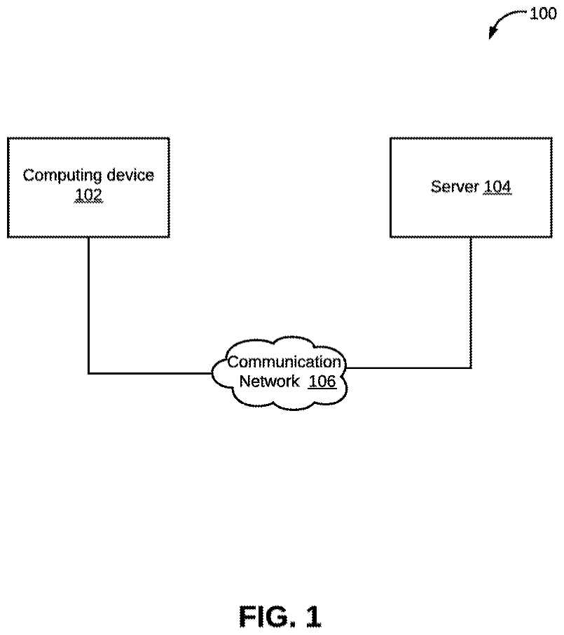

FIG. 1 is a diagram that illustrates an environment 100 for managing metadata of a table, in accordance with an exemplary embodiment of the present disclosure.

The environment 100 may include a computing device 102 configured for managing metadata of the table. Examples of the computing device 102 may include, but is not limited to, a smartphone, a laptop, a desktop, a tablet, and the like. As will be appreciated, in order to manage the metadata of the table, the computing device 102 may receive a user input corresponding to the table. The table may be one an existing table or a new table. Further, the user input may be for at least one of a modification of the existing table, or a creation of the new table. Upon receiving the user input, the computing device 102 may be configured to retrieve at least one predefined policy associated with an entity. The at least one predefined policy may be associated with a metadata element within metadata of the table. The metadata may include information associated with the table in compliance with requirements of the entity. In an embodiment, the metadata may correspond to data definition language (DDL) statements of the table.

Examples of the metadata element may include, but is not limited to, business definition, column definition, values allowed per column, business team definition, technical team definition, support team definition, job required to load the table, different sources from which the table is loaded, load frequency of the table, dependent downstream tables of the table, upstream tables on which the table load is dependent on, business domain of the table, column lineage, and similar other custom metadata fields. Examples of the predefined policies generated by the entity may include, but is not limited to, providing business definition of the table is mandatory, providing column definition for a column is mandatory, and providing technical team definition which owns the table is mandatory, providing table definition of the table is mandatory, providing load frequency of the table is mandatory, providing business domain of the table is mandatory, and the like. As will be appreciated, the above listed metadata elements of the table, and the predefined policies associated with the entity are exemplary and are used for ease of explanation. However, any number metadata elements and the predefined policies may be configured by the entity as per their needs.

In an embodiment, the at least one predefined policy associated with the entity may be retrieved from a server 104. In an embodiment, the computing device 102 may interact with the server 104 via a communication network 106. Examples of the communication network 106 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. In an embodiment, the communication network 106 may facilitate data exchange between the computing device 102 to the server 104.

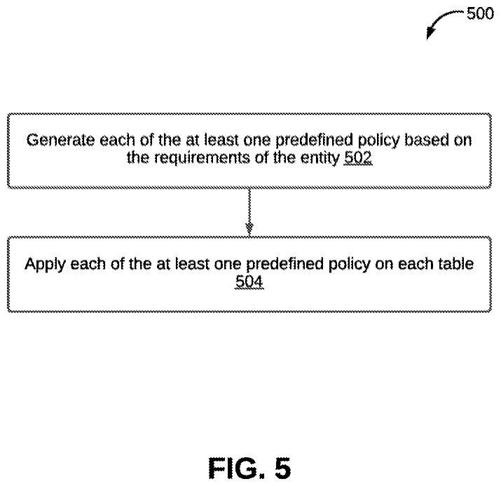

As will be appreciated, each of the at least one predefined policy may be defined by entities (business organizations) based on their organizational requirements. In particular, each of the at least one predefined policy may be defined by important members (such as members of board) of an entity based on the requirements of the entity. A method of generating the at least one predefined policy is further explained in detail in conjunction with FIG. 5. Further, upon retrieving the at least one predefined policy, the computing device 102 may validate the user input based on the at least one predefined policy. The validation may be one of a successful validation or an unsuccessful validation. In an embodiment, the successful validation may be when the presence of a definition is determined within the metadata. Further, the unsuccessful validation may be when the absence of the definition is determined within the metadata.

By way of an example, consider a scenario where an entity (or an organization) may have defined a predefined policy saying, ‘providing table definition is mandatory’ corresponding to a table definition metadata element. In this scenario, upon receiving a user input for creating a new table, the computing device 102 may retrieve the predefined policy (i.e., providing table definition is mandatory) associated with the entity from the server 104. In other words, upon receiving the user input corresponding to creation of the new table, the computing device 102 may identify if any policies have been predefined by the entity for creation or modification of a table. In an embodiment, each of the at least one predefined policy may be generated and stored within a database of the server 104. Further, the computing device may retrieve the predefined policy from the database of the server 104. Upon retrieving the predefined policy, the computing device 102 may validate the user input based on the predefined policy.

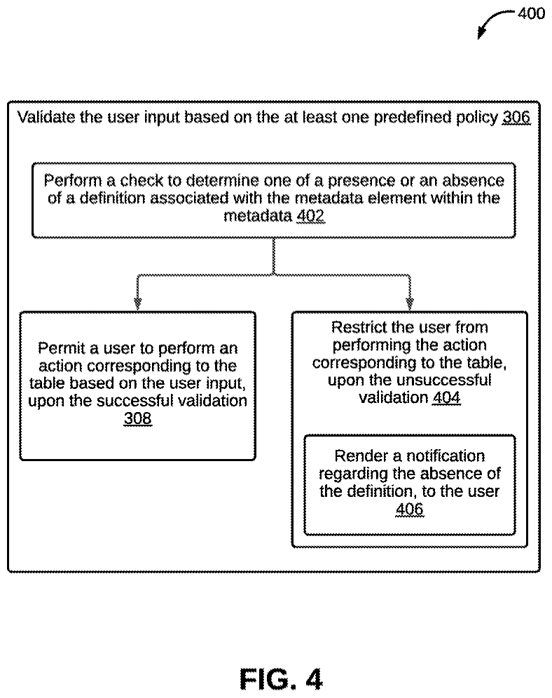

In order to validate the user input, the computing device 102 may perform a check to determine whether the definition for the table being created is present within the metadata. In other words, the computing device 102 may identify whether a user (e.g., a developer creating the table) has stated the definition of the table being created within the metadata prior to creating the table as per the predefined policy, i.e., “providing table definition is mandatory”. In particular, the computing device 102 may perform a check to determine whether the DDL statements (i.e., the metadata) includes the definition of the table definition. In first embodiment, based on the check performed, when the definition for the table is present within the metadata, then the validation of the user input may be the successful validated. In second embodiment, based on the check performed, when the definition for the table is not present within the metadata, then the validation of the user input may be the unsuccessful validated. A method of validating the user input is further explained in detail in conjunction with FIG. 4.

Further, upon the successful validation of the user input, the computing device 102 may permit the user to an action corresponding to the table. In addition, upon the unsuccessful validation of the user input, the user may be restricted from performing the action corresponding to the table. Examples of the action may include creation of the new table, insertion of one or more columns or rows, deletion of one or more columns or rows, updating one or more columns or rows, and the like. In continuation to the above example, when the user input is successfully validated, then the computing device 102 may permit the user to create the new table. In other words, when the definition of the table being created is stated by the user within the metadata of the table based on the predefined policy, then the user may be able to create the new table. Further, when the user input is unsuccessfully validated, then the computing device 102 may restrict the user from creating the new table. In other words, if an organization policy (i.e., the predefined) is defined saying ‘table definition is mandatory’, then all table creation DDL statements (i.e., the metadata) which do not have ‘metadata.table_definition’ defined within the DDL statements will not be executed.

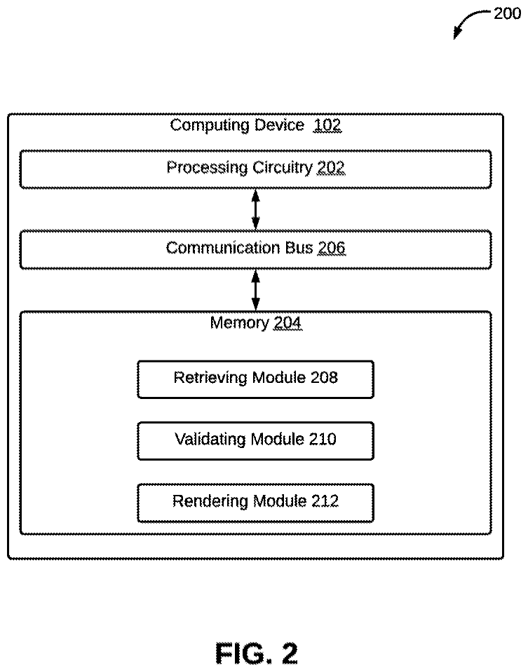

In order to restrict the user, the computing device 102 may render a notification to the user. The notification may include an alert to update the definition corresponding to the table definition metadata element within the metadata. In other words, when the definition of the table being created is not stated by the user within the metadata of the table as per the predefined policy, then the user may be restricted from creating the new table and the notification may be rendered to the user to update the table definition first within the metadata. The above technique of managing the metadata of the table is further explained in detail in conjunction with FIGS. 2-6.

As will be appreciated, the above discussed technique that is performed by the computing device 102 may provide a way for entities (i.e., the organizations) to enforce updating of the metadata corresponding to the table before any changes are made to the table. In other words, using the above discuss technique, the organizations may mandate the updating of the definition of the metadata element within the metadata before enabling the user to perform the desired action on the table. The above discussed technique may be licensed to database entities (i.e., companies or organizations). The database entities may use the technique for their databases, which in turn will help business across industry segments to adapt the discussed technique for maintaining the metadata of the table at a table level and a column level of the table.

FIG. 2 is a block diagram 200 that illustrates a computing device 102 configured for managing metadata of a table, in accordance with an exemplary embodiment of the present disclosure. FIG. 2 is explained in conjunction with FIG. 1. The computing device 102 may include a processing circuitry 202, and a memory 204 communicatively coupled to the processing circuitry 202 via a communication bus 206.

The memory 204 may store various data that may be captured, processed, and/or required by the computing device 102. The memory 204 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The memory 204 may also store processor-executable instructions. The processor-executable instructions, when executed by the processing circuitry 202, may cause the processing circuitry 202 to implement one or more embodiments of the present disclosure such as, but not limited to, receiving a user input corresponding to the table, retrieving at least one predefined policy associated with an entity, validating the user input based on the at least one predefined policy, permitting a user to perform an action corresponding to the table based on the user input, and the like. The memory 204 may include a retrieving module 208, a validating module 210, a rendering module 212. The memory 204 may also include a data store (not shown in FIG. 2) for storing data and intermediate results generated by the engines 208-212.

Initially, the computing device 102 may be configured to receive a user input. The user input may be received corresponding to the table. The table may be one or an existing table or a new table. In addition, the user input may be for at least one of a modification of the exiting table or creation of the new table. Upon receiving the user input, the retrieving module 208 may be configured for retrieving at least one predefined policy associated with an entity through the processing circuitry 202. In an embodiment, each of the at least one predefined policy may be generated and stored within the data store (not shown) present within the memory 204. The at least one predefined policy may be associated with a metadata element within metadata of the table. Further, the metadata may include information associated with the table in compliance with requirements of the entity. In an embodiment, the metadata may correspond to the DDL statements associated with the table.

Examples of the metadata element may include, but is not limited to, business definition, column definition, values allowed per column, business team definition, technical team definition, support team definition, job required to load the table, different sources from which the table is loaded, load frequency of the table, dependent downstream tables of the table, upstream tables on which the table load is dependent on, business domain of the table, column lineage, and similar other custom metadata fields. Examples of the predefined policies generated by the entity may include, but is not limited to, providing business definition of the table is mandatory, providing column definition for a column is mandatory, and providing technical team definition which owns the table is mandatory, providing table definition of the table is mandatory, providing load frequency of the table is mandatory, providing business domain of the table is mandatory, and the like.

Once the at least one predefined policy is retrieved, the validation module 210 may be configured to validate the user input based on the at least one predefined policy. The validation may be one of a successful validation or an unsuccessful validation. In order to validate the user input, the validation module 210 may be configured to check one of a presence or an absence of the of a definition associated with the metadata element within the metadata, based on the user input and the at least one predefined policy. In an embodiment, the successful validation may be when the presence of the definition is determined within the metadata. Further, the unsuccessful validation may be when the absence of the definition is determined within the metadata.

Further, based on the check performed, upon the successful validation, the validation module 210 may permit a user (e.g., a developer or a tester) to perform an action corresponding to the table based on the user input. Further, based on the check performed, upon the unsuccessful validation, the validation module 210 may be configured to restrict the user from performing the action corresponding to the table. In order to restrict the user, upon the unsuccessful validation, the validation module 210 may be configured to generate a notification regarding the absence of the definition associated with the metadata element within the metadata. Examples of the action may include creation of the new table, insertion of one or more columns or rows, deletion of one or more columns or rows, updating one or more columns or rows, and the like.

Further, the rendering module 212 may be configured to render one or more results via a Graphical User Interface (GUI). By way of an example, the rendering module 212 may render a pop-up message displaying ‘user input successfully validated’, upon the successful validation of the user input. In addition, upon the successful validation when the permission is provided to the user to perform the action, the rendering module 212 may be configured to render the table corresponding to which the user may perform the action. Further, the rendering module 212 may be configured to render the notification generated by the validation module 210 regarding the absence of the definition of the metadata element. The notification may be an alert to update the definition corresponding to the metadata element within the metadata. In other words, the alert may indicate the user to update the definition of the metadata element within the DDL statements to perform desired action corresponding to the table.

It should be noted that all such aforementioned module 208-212 may be represented as a single module or a combination of different modules. Further, as will be appreciated by those skilled in the art, each of the modules 208-212 may reside, in whole or in parts, on one device or multiple devices in communication with each other. In some embodiments, each of the modules 208-212 may be implemented as dedicated hardware circuit comprising custom application-specific integrated circuit (ASIC) or gate arrays, off-the-shelf semiconductors such as logic chips, transistors, or other discrete components. Each of the modules 208-212 may also be implemented in a programmable hardware device such as a field programmable gate array (FPGA), programmable array logic, programmable logic device, and so forth. Alternatively, each of the modules 208-212 may be implemented in software for execution by various types of processors (e.g., the processing circuitry 202). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for managing tables metadata. For example, the exemplary computing device 102 may manage the metadata of the table by the processes discussed herein. In particular, as will be appreciated by those of ordinary skill in the art, control logic and/or automated routines for performing the techniques and steps described herein may be implemented by the computing device 102 either by hardware, software, or combinations of hardware and software. For example, suitable code may be accessed and executed by the one or more processors on the computing device 102 to perform some or all of the techniques described herein. Similarly, application specific integrated circuits (ASICs) configured to perform some, or all of the processes described herein may be included in the one or more processors on the computing device 102.

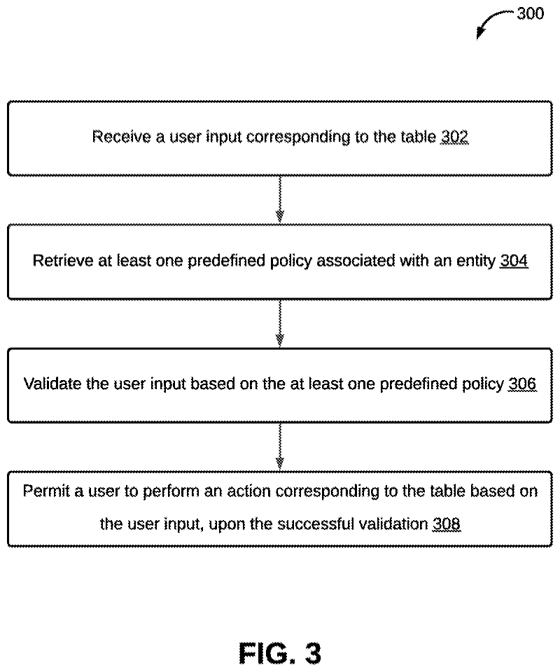

FIG. 3 is a flow diagram that illustrates an exemplary process 300 for managing metadata of a table, in accordance with an exemplary embodiment of the present disclosure. FIG. 3 is explained in conjunction with FIGS. 1 and 2. In an embodiment, the process 300 may be implemented by the computing device 102.

In order to manage the metadata of the table, initially, at step 302, a user input may be received corresponding to the table. In an embodiment, the table may be one an existing table or a new table. Further, the user input may be received for at least one of a modification of the existing table, or a creation of the new table. The modification of the existing table may include, but is not limited to, insertion of one or more columns or rows, deletion of one or more columns or rows, updating one or more columns or rows, and the like.

Upon receiving the user input, at step 304, at least one predefined policy associated with an entity (or an organization) may be retrieved. The at least one predefined policy may be associated with a metadata element within metadata of the table. Further, the metadata may include information associated with the table in compliance with requirements of the entity. In an embodiment, the metadata may correspond to DDL statements associated with the table. Examples of the metadata element may include, but is not limited to, business definition, column definition, values allowed per column, business team definition, technical team definition, support team definition, job required to load the table, different sources from which the table is loaded, load frequency of the table, dependent downstream tables of the table, upstream tables on which the table load is dependent on, business domain of the table, column lineage, and similar other custom metadata fields.

Based on these metadata elements, the entity may generate predefined policies based on their requirements. Examples of the predefined policies may include, but is not limited to, providing business definition of the table is mandatory, providing column definition for a column is mandatory, and providing technical team definition which owns the table is mandatory, providing, table definition of the table is mandatory, providing load frequency of the table is mandatory, providing business domain of the table is mandatory, and the like. As will be appreciated, the above listed metadata elements of the table, and the predefined policies associated with the entity are exemplary and are used for ease of explanation. However, any number metadata elements and the predefined policies can be configured by the entity as per their needs. A method of generating the predefined policies has been further explained in detail in conjunction with FIG. 5.

Further, once the at least predefined policy is retrieved, then at step 306, the user input may be validated based on the at least one predefined policy. The validation may be one of a successful validation or an unsuccessful validation. The successful validation may be when a definition associated with the metadata element is present within the metadata of the table. Whereas the unsuccessful validation may be when the definition of the metadata element is not present within the metadata of the table. A method of validating the user input is further explained in detail in conjunction with FIG. 4. Further, upon the successful validation, at step 308, the user may be permitted to perform an action corresponding to the table based on the user input. Examples of the action may include creation of the new table, insertion of one or more columns or rows, deletion of one or more columns or rows, updating one or more columns or rows, and the like.

Consider a scenario where an entity may have generated a set of three predefined policies, e.g., providing business definition of the table is mandatory, providing column definition for a column is mandatory, and providing technical team definition which owns the table is mandatory. As will be appreciated, for ease of explanation only three predefined policies are considered. However, as per the entity's requirements any number of policies may be defined and enforced by the entity for any number of metadata elements. It should be noted that an admin of a database having the table, or an admin of the table may be able to enforce a required predefined policy from the predefined policies generated by the entity, based on their requirements.

In such scenario, once the set of three predefined policies are generated and generated and enforced on users (e.g., developers or testers), then the users may be allowed to perform one or more actions for creation or modification of the table based on the set of three predefined policies. For example, suppose the user input for creating a new table is received from the user. Then, upon receiving the user input, each of the set of three predefined policies associated with the entity may be retrieved. As will be appreciated, the each of the set of three predefined policies may be retrieved from the entity's database (same as the database of the server 104). Once each of the set of three predefined policies is retrieved, then the user input may be validated based on the set of three predefined policies.

In order to validate the user input, a check may be performed to determine the presence or the absence of the definition of each metadata element that may be required for creating the new table is defined within the metadata (i.e., the DDL statements). In particular, the check may be performed to determine whether the user has provided the definition of each metadata element within the metadata, as the user input. For example, the check may be performed to determine whether a business definition (i.e., a metadata element) is provided for the new table within the metadata as per a first predefined policy of the set of predefined policies, i.e., providing business definition of the table is mandatory. By way of another, the check may be performed to determine whether a column definition (metadata element) is provided for each column being inserted in the table based a second predefined policy, i.e., providing column definition for a column is mandatory. In a similar manner, the user input may be validated based on each of the set of three predefined policies. An exemplary sample of creating the new table including the definition of the metadata element within the metadata is depicted below:

create table <table name>
column1 data_type <constraints if any>,
column2 data_type <constraints if any>,
...
<below statements are optional but can be enforced based on predefined
policies of the entity>
Metadata.business_definition <Business definition of the table>
Metadata.Column_Definition column1 <Business description of the column1>
Metadata.Column_Definition column2 <Business description of the column2>
Metadata.Technical Team_Definition <Information about which team owns the
table>
<custom metadata elements can be defined as per entity's policies>
)

In another scenario, where the user input is for modification of an existing table. In this scenario, the user may be permitted to modify the existing table as per the predefined policy. For example, consider a predefined policy generated and enforced by the entity is ‘providing column definition for a column is mandatory’ and the user input is to add a new column to the table. In this case, the user input received for addition of the column to the table may be validated based on the predefined policy, ‘providing column definition for a column is mandatory’. In order to validate the user input, the check may be performed to determine whether the definition of the column being added is present or not within the metadata (i.e., the DDL statements required for creating the table). In one embodiment, when the column definition of the table is present within the metadata, then the user may be permitted to perform an action (i.e., the addition of the column) in the existing table. In another embodiment, when the column definition of the table is not present, then the user may be restricted from performing the action of adding the column in the existing table. This is further explained in detail in conjunction with FIG. 4.

As will be appreciated, using the above discussed process, the metadata may be tightly coupled with the corresponding table as any number of custom metadata details of the metadata elements in the table is stored both at a table level and a column level. All table level metadata may be defined within a key value pair format ensuring custom metadata elements are used as per the need of the entity. Further, all column level metadata of the table will be defined in triple format where a first field will indicate a type of the metadata element, a second field will indicate a column for which the metadata element is intended for, and third field will indicate the definition of the metadata element as depicted via the exemplary sample of creating the new table.

FIG. 4 is a flow diagram that illustrates an exemplary process 400 of validating a user input, in accordance with an exemplary embodiment of the present disclosure. FIG. 4 is explained in conjunction with FIGS. 1, 2, and 3. In an embodiment, the process 400 may be implemented by the computing device 102.

In order to validate the user input received corresponding to the table as mentioned via step 306 initially, at step 402, a check may be performed to determine one of the presence or the absence of the definition associated with the metadata element within the metadata. The check may be performed based on the user input and the at least one predefined policy. In one embodiment, based on the check performed, upon the successful validation when the presence of the definition associated with the metadata element is determined to be present within the metadata, then step 308 may be executed. In other words, upon the successful validation, the user may be permitted to perform the desired action.

Further, based on the check performed, upon the unsuccessful validation, when the presence of the definition associated with the metadata element is determined to be absent within the metadata, then at step 404, the user may be restricted from performing the action associated with the table. Further, in order to restrict the user, at step 406, the notification regarding the absence of the definition may be rendered to the user. In an embodiment, the notification may include the alert to update the definition corresponding to the metadata element within the metadata.

By way of an example, suppose the user input is for creation of the new table, and the predefined policy is ‘providing load frequency for a table is mandatory’ for a metadata element, i.e., ‘the load frequency of the table’. In this case, the check may be performed to validate the user input. The check may be performed to determine a presence, or an absence of the definition associated with the metadata element, i.e., ‘the load frequency of the table’ within the metadata, based on the predefined policy, i.e., ‘providing load frequency for the table is mandatory’. In one embodiment, when the definition for ‘the load frequency of the table’ is present, then the user may be permitted to perform the action (i.e., the creation of the new table). In another embodiment, when the definition for ‘the load frequency of the table’ is not present, then the user may be restricted from performing the action of the creation of the new table. To restrict the user, the notification regarding the absence of the definition may be rendered to the user. The notification may be the alert to update the definition of the metadata element within the metadata, for example, ‘update the definition of ‘the load frequency metadata element’, may be rendered to the user.

FIG. 5 is a flow diagram that illustrates an exemplary process 500 of applying predefined policies on a table, in accordance with an exemplary embodiment of the present disclosure. FIG. 5 is explained in conjunction with FIGS. 1, 2, 3, and 4. In an embodiment, the process 500 may be implemented by the computing device 102.

At step 502, each of the at least one predefined policy may be generated based on the requirements of the entity. By way of an example, in some embodiment, each predefined policy may be selected from a list of predefined policies rendered to a user (e.g., a board member) of the entity, based on the requirements of the entity. In some another embodiment, a set of predefined policies that will be beneficial for the entity for managing the tables may be automatically generated and rendered to the board member. The board member may select one or more predefined policies from the set of predefined policies based on their entity's requirements. In yet another embodiment, the board member may manually define each predefined policy based on the requirements of the entity.

Examples of the predefined policies generated by the entity may include, but is not limited to, providing business definition of the table is mandatory, providing column definition for a column is mandatory, and providing technical team definition which owns the table is mandatory, providing, table definition of the table is mandatory, providing load frequency of the table is mandatory, providing business domain of the table is mandatory, and the like. As will be appreciated, the above-listed predefined policies associated with the entity are exemplary and are used for ease of explanation.

Once each of the at least one predefined policy is generated, then at step 504, each predefined policy may be applied on each table. As will be appreciated, the admin of the database having the table, or the admin of the table may apply one or more predefined policies generated by the entity, based on their needs. In other words, the admin may partially or fully enforce each predefined policy based on their requirements. For example, in case of partial enforcement, the admin may apply each predefined policy for new tables being created. Further, in case of full enforcement, the admin may apply each predefined policy even on modification being performed on existing tables.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

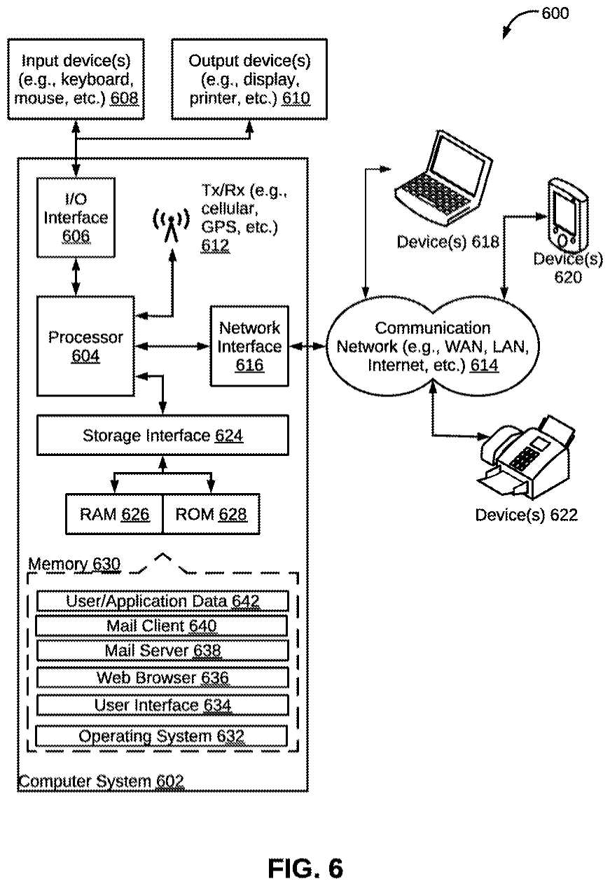

The disclosed methods and systems may be implemented on a conventional or a general-purpose computer system, such as a personal computer (PC) or server computer. FIG. 6 is a block diagram that illustrates a system architecture 600 of a computer system 602 for managing extensions of a product, in accordance with an exemplary embodiment of the present disclosure. Variations of computer system 602 may be used for implementing computing device 102 for managing metadata of a table. Computer system 602 may include a central processing unit (“CPU” or “processor”) 604. Processor 604 may include at least one data processor for executing program components for executing user or system-generated requests. A user may include a person, a person using a device, such as those included in this disclosure, or such a device itself. Processor 604 may include specialized processing units such as integrated system (bus) controllers, memory management control units, floating point units, graphics processing units, digital signal processing units, etc. Processor 604 may include a microprocessor, such as AMD® ATHLOM® microprocessor, DURON® microprocessor OR OPTERON® microprocessor ARM's application, embedded or secure processors, IBM® POWERPC®, INTEL'S CORE® processor, ITANIUM® processor, XEON® processor, CELERON® processor or other line of processors. Processor 604 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 604 may be disposed in communication with one or more input/output (I/O) devices via an I/O interface 606. The I/O interface 606 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (for example, code-division multiple access (CDMA), high-speed packet access (HSPA+), global system for mobile communications (GSM), long-term evolution (LTE), WiMAX, or the like), etc.

Using I/O interface 606, computer system 602 may communicate with one or more I/O devices. For example, an input device 608 may be an antenna, keyboard, mouse, joystick, (infrared) remote control, camera, card reader, fax machine, dongle, biometric reader, microphone, touch screen, touchpad, trackball, sensor (for example, accelerometer, light sensor, GPS, gyroscope, proximity sensor, or the like), stylus, scanner, storage device, transceiver, video device/source, visors, etc. An output device 610 may be a printer, fax machine, video display (for example, cathode ray tube (CRT), liquid crystal display (LCD), light-emitting diode (LED), plasma, or the like), audio speaker, etc. In some embodiments, a transceiver 612 may be disposed in connection with processor 604. Transceiver 612 may facilitate various types of wireless transmission or reception. For example, transceiver 612 may include an antenna operatively connected to a transceiver chip (for example, TEXAS® INSTRUMENTS WILINK WL1286® transceiver, BROADCOM® BCM4550IUB8® transceiver, INFINEON TECHNOLOGIES® X-GOLD 618-PMB9800® transceiver, or the like), providing IEEE 802.6a/b/g/n, Bluetooth, FM, global positioning system (GPS), 2G/3G HSDPA/HSUPA communications, etc.

In some embodiments, processor 604 may be disposed in communication with a communication network 614 via a network interface 616. Network interface 616 may communicate with communication network 614. Network interface 616 may employ connection protocols including, without limitation, direct connect, Ethernet (for example, twisted pair 10/100/1000 Base T), transmission control protocol/internet protocol (TCP/IP), token ring, IEEE 802.11 a/b/g/n/x, etc. Communication network 614 may include, without limitation, a direct interconnection, local area network (LAN), wide area network (WAN), wireless network (for example, using Wireless Application Protocol), the Internet, etc. Using network interface 616 and communication network 614, computer system 602 may communicate with devices 618, 620, and 622. These devices may include, without limitation, personal computer(s), server(s), fax machines, printers, scanners, various mobile devices such as cellular telephones, smartphones (for example, APPLE® IPHONE® smartphone, BLACKBERRY® smartphone, ANDROID® based phones, etc.), tablet computers, eBook readers (AMAZON® KINDLE® reader, NOOK® tablet computer, etc.), laptop computers, notebooks, gaming consoles (MICROSOFT® XBOX® gaming console, NINTENDO® DS® gaming console, SONY® PLAYSTATION® gaming console, etc.), or the like. In some embodiments, computer system 602 may itself embody one or more of these devices.

In some embodiments, processor 604 may be disposed in communication with one or more memory devices (for example, RAM 626, ROM 628, etc.) via a storage interface 624. Storage interface 624 may connect to memory 630 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory 630 may store a collection of program or database components, including, without limitation, an operating system 632, user interface application 634, web browser 636, mail server 638, mail client 640, user/application data 642 (for example, any data variables or data records discussed in this disclosure), etc. Operating system 632 may facilitate resource management and operation of computer system 602. Examples of operating systems 632 include, without limitation, APPLE® MACINTOSH® OS X platform, UNIX platform, Unix-like system distributions (for example, Berkeley Software Distribution (BSD), FreeBSD, NetBSD, OpenBSD, etc.), LINUX distributions (for example, RED HAT®, UBUNTU®, KUBUNTU®, etc.), IBM® OS/2 platform, MICROSOFT® WINDOWS® platform (XP, Vista/7/8, etc.), APPLE® IOS® platform, GOOGLE® ANDROID® platform, BLACKBERRY® OS platform, or the like. User interface 634 may facilitate display, execution, interaction, manipulation, or operation of program components through textual or graphical facilities. For example, user interfaces may provide computer interaction interface elements on a display system operatively connected to computer system 602, such as cursors, icons, check boxes, menus, scrollers, windows, widgets, etc. Graphical user interfaces (GUIs) may be employed, including, without limitation, APPLE® Macintosh® operating systems' AQUA® platform, IBM® OS/2® platform, MICROSOFT® WINDOWS® platform (for example, AERO® platform, METRO® platform, etc.), UNIX X-WINDOWS, web interface libraries (for example, ACTIVEX® platform, JAVA® programming language, JAVASCRIPT® programming language, AJAX® programming language, HTML, ADOBE® FLASH® platform, etc.), or the like.

In some embodiments, computer system 602 may implement a web browser 636 stored program component. Web browser 636 may be a hypertext viewing application, such as MICROSOFT® INTERNET EXPLORER® web browser, GOOGLE® CHROME® web browser, MOZILLA® FIREFOX® web browser, APPLE® SAFARI® web browser, etc. Secure web browsing may be provided using HTTPS (secure hypertext transport protocol), secure sockets layer (SSL), Transport Layer Security (TLS), etc. Web browsers may utilize facilities such as AJAX, DHTML, ADOBE® FLASH® platform, JAVASCRIPT® programming language, JAVA® programming language, application programming interfaces (APIs), etc. In some embodiments, computer system 602 may implement a mail server 638 stored program component. Mail server 638 may be an Internet mail server such as MICROSOFT® EXCHANGE® mail server, or the like. Mail server 638 may utilize facilities such as ASP, ActiveX, ANSI C++/C#, MICROSOFT .NET® programming language, CGI scripts, JAVA® programming language, JAVASCRIPT® programming language, PERL® programming language, PHP® programming language, PYTHON® programming language, WebObjects, etc. Mail server 638 may utilize communication protocols such as internet message access protocol (IMAP), messaging application programming interface (MAPI), Microsoft Exchange, post office protocol (POP), simple mail transfer protocol (SMTP), or the like. In some embodiments, computer system 602 may implement a mail client 640 stored program component. Mail client 640 may be a mail viewing application, such as APPLE MAIL® mail-client, MICROSOFT ENTOURAGE® mail client, MICROSOFT OUTLOOK® mail client, MOZILLA THUNDERBIRD® mail client, etc.

In some embodiments, the computer system 602 may store user/application data 642, such as the data, variables, records, etc. as described in this disclosure. Such databases may be implemented as fault-tolerant, relational, scalable, secure databases such as ORACLE® database OR SYBASE® database. Alternatively, such databases may be implemented using standardized data structures, such as an array, hash, linked list, struct, structured text file (for example, XML), table, or as object-oriented databases (for example, using OBJECTSTORE® object database, POET® object database, ZOPE® object database, etc.). Such databases may be consolidated or distributed, sometimes among the various computer systems discussed above in this disclosure. It is to be understood that the structure and operation of the any computer or database component may be combined, consolidated, or distributed in any working combination.

Thus, the disclosed method and system try to overcome the technical problem of managing metadata of a table. The disclosed method and system may receive a user input corresponding to the table. The table may be one an existing table or a new table. The user input may be received corresponding to at least one of a modification of the existing table, or a creation of the new table. Further, the disclosed method and system may retrieve at least one predefined policy associated with an entity, upon receiving the user input. The at least one predefined policy may be associated with a metadata element within a metadata of the table. The metadata may include information associated with the table in compliance with requirements of the entity. In addition, the disclosed method and system may validate the user input based on the at least one predefined policy. The validation may be one of a successful validation or an unsuccessful validation. Thereafter, the disclosed method and system may permit a user to perform an action corresponding to the table based on the user input, upon the successful validation.

As will be appreciated by those skilled in the art, the techniques described in the various embodiments discussed above are not routine, or conventional, or well understood in art. The techniques discussed above provide managing metadata of a table. The above discussed techniques may provide tight coupling of tables with their corresponding metadata in a way such that there are provisions to store and maintain the metadata at the table level itself. This may increase reliability of the metadata for a long period of time and may enable members of support or business teams to access the metadata of the table as and when the need arises. The above discussed technique may enable entities or organizations to customize metadata elements (or metadata fields) as per their requirements. In order to customize the metadata elements, the entities (i.e., the organizations) may define one or more policies based on their requirements. Further, the above discussed technique may provide flexibility to an admin of a database including the table or an admin of the table, to enforce updating of the metadata elements within the metadata stored in the database based on the predefined organization policies. In other words, the admin of the database may be able to enforce defining of certain metadata elements as mandatory for one or more tables without which the DDL statements will fail to execute. The enforcement for defining the metadata elements may vary from organization to organization and each organization can have their customized enforcement. In addition, the above discussed technique provides a provision to collate information associated with the metadata elements and made it available to be queried individually for each table as well as collectively for all the tables from a single view of the table or a set of views of the tables. Moreover, using the discussed techniques, the admin may be able to block the creation of the table if it does not meet standards defined by the organization as per the organizational policies. In addition to blocking the creation, the modification of the table may be blocked by the admin if any of the mandatory metadata elements are not defined as per the organization policies.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a method and system for managing metadata of a table. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing metadata of a table, the method comprising:
receiving, by a computing device, a user input corresponding to the table, wherein the table is one an existing table or a new table, and wherein the user input is corresponding to at least one of a modification of the existing table, or a creation of the new table;
upon receiving the user input, retrieving, by the computing device, at least one predefined policy associated with an entity, wherein the at least one predefined policy is associated with a metadata element within metadata of the table, and wherein the metadata comprises information associated with the table in compliance with requirements of the entity;
validating, by the computing device, the user input based on the at least one predefined policy, wherein the validation is one of a successful validation or an unsuccessful validation; and
permitting, by the computing device, a user to perform an action corresponding to the table based on the user input, upon the successful validation.

2. The method claim 1, wherein validating the user input comprises:
performing a check to determine one of a presence or an absence of a definition associated with the metadata element within the metadata, based on the user input and the at least one predefined policy.

3. The method of claim 2, wherein the successful validation is when the presence of the definition is determined within the metadata, and wherein the unsuccessful validation is when the absence of the definition is determined within the metadata.

4. The method of claim 1, wherein upon the unsuccessful validation, restricting the user from performing the action corresponding to the table.

5. The method of claim 4, wherein restricting the user comprises:
rendering a notification regarding the absence of the definition to the user, and wherein the notification comprises an alert to update the definition corresponding to the metadata element within the metadata.

6. The method of claim 1, further comprising:
generating each of the at least one predefined policy based on the requirements of the entity; and
applying each of the at least one predefined policy on each table.

7. A system for managing metadata of a table, the system comprising:
a processing circuitry; and
a memory communicatively coupled to the processing circuitry, wherein the memory stores processor instructions, which when executed by the processing circuitry, cause the processing circuitry to:
receive a user input corresponding to the table, wherein the table is one an existing table or a new table, and wherein the user input is corresponding to at least one of a modification of the existing table, or a creation of the new table;
upon receiving the user input, retrieve at least one predefined policy associated with an entity, wherein the at least one predefined policy is associated with a metadata element within metadata of the table, and wherein the metadata comprises information associated with the table in compliance with requirements of the entity;
validate the user input based on the at least one predefined policy, wherein the validation is one of a successful validation or an unsuccessful validation; and
permit a user to perform an action corresponding to the table based on the user input, upon the successful validation.

8. The system of claim 7, wherein, to validate the user input, the processor instructions, on execution, further cause the processing circuitry to:
perform a check to determine one of a presence or an absence of a definition associated with the metadata element within the metadata, based on the user input and the at least one predefined policy.

9. The system of claim 8, wherein the successful validation is when the presence of the definition is determined within the metadata, and wherein the unsuccessful validation is when the absence of the definition is determined within the metadata.

10. The system of claim 7, wherein, upon the unsuccessful validation, the processor instructions, on execution, further cause the processing circuitry to restrict the user from performing the action corresponding to the table.

11. The system of claim 10, wherein, to restrict the user, the processor instructions, on execution, further cause the processing circuitry to:
render a notification regarding the absence of the definition to the user, and wherein the notification comprises an alert to update the definition corresponding to the metadata element within the metadata.

12. The system of claim 7, wherein the processor instructions, on execution, further cause the processing circuitry to:
generate each of the at least one predefined policy based on the requirements of the entity; and
apply each of the at least one predefined policy on each table.

13. A non-transitory computer-readable medium storing computer-executable instructions for managing metadata of a table, the stored instructions, when executed by a processor, cause the processor to perform operations comprises:
receiving a user input corresponding to the table, wherein the table is one an existing table or a new table, and wherein the user input is corresponding to at least one of a modification of the existing table, or a creation of the new table;
upon receiving the user input, retrieving at least one predefined policy associated with an entity, wherein the at least one predefined policy is associated with a metadata element within metadata of the table, and wherein the metadata comprises information associated with the table in compliance with requirements of the entity;
validating the user input based on the at least one predefined policy, wherein the validation is one of a successful validation or an unsuccessful validation; and
permitting a user to perform an action corresponding to the table based on the user input, upon the successful validation.
